(19) United States
(12) Patent Application Publication
(10) Pub. No.: US 2024/0283274 A1
(43) Pub. Date: Aug. 22, 2024

(54) CHARGING INTEGRATED CIRCUITS

(71) Applicant: SAMSUNG ELECTRONICS CO., LTD., Suwon-si (KR)

(72) Inventors: Sungwoo Lee, Suwon-si (KR); Sungwoo Moon, Suwon-si (KR); Jinwoo So, Suwon-si (KR); Daewoong Cho, Suwon-si (KR); Yonghwan Cho, Suwon-si (KR); Jungwook Heo, Suwon-si (KR)

(21) Appl. No.: 18/583,593

(22) Filed: Feb. 21, 2024

(30) Foreign Application Priority Data
Feb. 22, 2023 (KR) 10-2023-0023791
Oct. 6, 2023 (KR) 10-2023-0133697

(51) Int. Cl. H02J 7/00

(52) U.S. Cl. CPC H02J 7/00712; H02J 7/0048; H02J 2207/20

(57) ABSTRACT

A charging integrated circuit (IC) includes a battery, a switched capacitor IC comprising a second power stage for direct charging, and a switching charger IC comprising a first power stage for switching charging, a power meter configured to obtain information about input/output voltage and current, and a control circuit configured to perform switching charging by controlling the first power stage or perform direct charging through the switched capacitor IC by controlling the second power stage.

### CROSS-REFERENCE TO RELATED APPLICATIONS

This application is based on and claims priority under 35 U.S.C. § 119 to Korean Patent Application Nos. 10-2023-0023791, filed on Feb. 22, 2023, and 10-2023-0133697, filed on Oct. 6, 2023, in the Korean Intellectual Property Office, the disclosures of which are incorporated by reference herein in their entireties.

### BACKGROUND

As electronic technology develops, various types of electronic devices are being used. Mobile electronic devices may be driven by included battery devices. As the power consumption of electronic devices increases, battery capacity increases, and, accordingly, batteries may be charged at various speeds depending on the magnitude of voltage supplied by a charger, such as fast charging or normal charging.

### SUMMARY

Some aspects of this disclosure relate to integrated circuits (IC) and operating methods thereof, and more particularly, to charging ICs for charging a battery device and operating methods thereof.

For example, some aspects of this disclosure describe a switching charging integrated circuit (IC) that controls both direct charging and switching charging by separating a switching charger IC from a switched capacitor IC for direct charging.

According to some aspects of this disclosure, there is provided a charging integrated circuit (IC) including a battery, a switched capacitor IC including a second power stage for direct charging, and a switching charger IC including a first power stage for switching charging, a power meter configured to obtain information about input/output voltage and current, and a control circuit configured to perform switching charging by controlling the first power stage, or perform direct charging through the switched capacitor IC by controlling the second power stage.

According to some aspects of this disclosure, there is provided an operating method of a charging IC including a battery, a switching charger IC, and a switched capacitor IC including identifying whether an external power source connected to the charging IC supports direct charging, based on a level of charge of the battery, generating a control signal instructing direct charging, providing, to the switched capacitor IC, a control signal instructing direct charging, monitoring the level of charge of the battery, based on results of the monitoring, determining to perform switching charging, and bypassing generation of a control signal instructing direct charging, in response to the determining of switching charging.

According to some aspects of this disclosure, there is provided a charging IC including a battery, a first switched capacitor IC including a second power stage for direct charging, a second switched capacitor IC including a third power stage for direct charging, and a switching charger IC including a first power stage for switching charging, a power meter configured to obtain information about input/output voltage and current, and a control circuit configured to perform switching charging by controlling the first power stage, or perform direct charging through the first switched capacitor IC and the second switched capacitor IC by controlling the second power stage and the third power stage.

### BRIEF DESCRIPTION OF THE DRAWINGS

FIG. 1 is a block diagram showing an electronic device and an external power source, according to some implementations;

FIG. 2 is a detailed block diagram of a charging integrated circuit (IC) according to some implementations;

FIG. 3 shows an example of a charging IC according to some implementations;

FIG. 4A is a circuit diagram illustrating an example of a first power stage according to some implementations;

FIG. 4B is a circuit diagram illustrating an example of a second power stage according to some implementations;

FIG. 5 is a flowchart showing an operating method of a control circuit, according to some implementations;

FIG. 6 shows another example of a charging IC according to some implementations;

FIG. 7 is a flowchart showing an operating method of a control circuit, according to some implementations;

FIG. 8 shows an example of a charging IC according to a comparative example;

FIG. 9 shows an example of a charging IC according to a comparative example;

FIG. 10 is a signal exchange diagram according to some implementations; and

FIG. 11 is a block diagram showing a configuration of an electronic device including a charging IC according to some implementations.

### DETAILED DESCRIPTION

When a single charging IC supports multiple charging methods such as fast charging and normal charging, one or more characteristics of the charging IC may weakened, for example, because the size of the charging IC is enlarged, heat generation is difficult to control, an unwanted fast charging function may not be separated even when fast charging is not required, among other reasons. Implementations of this disclosure can provide improved performance by providing a switching charger IC and a switched capacitor IC in a charging IC, e.g., using a control circuit in the switching charger IC.

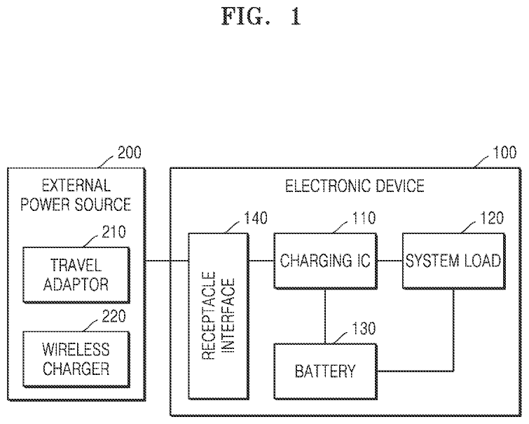

FIG. 1 is a block diagram showing an electronic device 100 and an external power source 200 according to some implementations.

FIG. 1 shows the electronic device 100 and the external power source 200. In order to charge a battery 130 included in the electronic device 100, the electronic device 100 and the external power source 200 may be connected to each other wired or wirelessly.

In some implementations, the electronic device 100 may include various electronic devices that a user may carry. For example, the electronic device 100 may be a mobile device such as a smart phone, a tablet personal computer (PC), a mobile phone, a personal digital assistant (PDA), a laptop, a wearable device, a global positioning system (GPS) device, an e-book terminal, a digital broadcasting terminal, an MP3 player, a digital camera, etc. As another example, the electronic device 100 may be an electric vehicle.

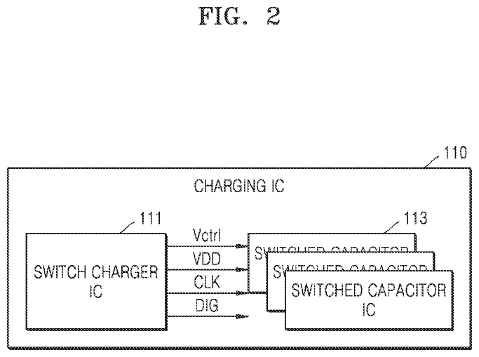

The electronic device 100 may include a charging integrated circuit (IC) 110. The charging IC 110 may be referred to as a “battery charger.” For example, the charging IC 110 may be implemented as an IC chip and may be mounted on a printed circuit board (PCB). The charging IC 110 may charge the battery 130 by receiving power from the external power source 200 and transferring the power to the battery 130, and may control the electronic device 100 to perform various functions by transferring the power to a system load 120. An example of a specific configuration of the charging IC 110 is described below with reference to FIG. 2.

In addition, the electronic device 100 may include the battery 130. The battery 130 may include at least one battery cell. For example, the battery 130 may correspond to a multi cell battery including a plurality of battery cells connected to each other in series. As another example, the battery 130 may correspond to a single cell battery including one battery cell. The battery 130 may receive power through the charging IC 110 when the electronic device 100 is connected to the external power source 200. When the electronic device 100 is not connected to the external power source 200, the battery 130 may control the electronic device 100 to perform various functions by providing power to the system load 120.

In addition, the electronic device 100 may include the system load 120. Although not shown, the system load 120 may include components of the electronic device 100 other than the charging IC 110 and the battery 130. For example, the system load 120 may include a display, an application processor, a communication processor, a speaker, a memory, etc. That is, the system load 120 may refer to chips, modules, operation blocks, functional blocks, and intellectual property (IP) blocks included in the electronic device 100. The system load 120 may receive power from the external power source 200 or the battery 130 and provide various functions to the user. For example, a monitor included in the system load 120 may provide visual recognition to the user by displaying objects through the display, the communication processor may transmit and receive data by exchanging wireless signals with an external device, and the application processor may perform various operations.

In addition, the electronic device 100 may include a receptacle interface 140. The receptacle interface 140 may connect the electronic device 100 to the external power source 200 through a universal serial bus (USB) cable. In some implementations, the receptacle interface 140 may correspond to a USB Type-C interface. The USB cable may correspond to a USB Type-C cable. The USB Type-C interface may be implemented based on the definition of USB 2.0, USB 3.1, USB 3.2, or USB4. The receptacle interface 140 may include a plurality of pins. The plurality of pins may include a pin for power supply, a pin for data transmission, and a configuration channel (CC) pin.

The external power source 200 may supply power to the electronic device 100. According to some implementations, the external power source 200 may include a travel adapter (TA) 210 and a wireless charger.

The wireless charger 220 may charge the electronic device 100 by transmitting power wirelessly through air instead of supplying power through a wire. According to some implementations, the wireless charger 220 may transmit power based on various wireless charging methods, such as magnetic induction, magnetic resonance, electromagnetic induction, and non-radiative wireless charging (WiTricity).

The TA 210 may supply power through a wire connected to the charging IC 110 of the electronic device 100. The TA 210 may convert power supplied from AC 110 V to 220 V, which is a household power source, or other power supply means (e.g., a computer), into DC power necessary for charging the battery 130 and provide the DC power to the electronic device 100. According to some implementations, the receptacle interface 140 may be electrically connected to an output terminal of an auxiliary battery. According to some implementations, the TA 210 may support direct charging.

FIG. 2 is a detailed block diagram of the charging IC 110 according to some implementations.

Referring to FIG. 2, the charging IC 110 may include a switching charger IC 111 and at least one switched capacitor IC 113.

The switching charger IC 111 may support switching charging, sometimes referred to as “switch-mode charging” or “switch charging.” “Switching charging” may refer to charging using a charging current adjusted by stepping down an input voltage and adjusting the cycle of a buck converter. Switching loss and conduction loss due to a resistance component of an inductor itself are inevitable, and thus, the charging efficiency of switching charging using an inductor may be lower than that of direct charging, which is described below.

At least one switched capacitor IC 113 may support direct charging. “Direct charging” may refer to charging the battery 130 by directly transferring an input voltage to the battery 130 through a power stage including a switched capacitor. In some implementations, direct charging uses only transistors and capacitors, which may be highly efficient charging that reduces switching loss and conduction loss due to the resistance component of the inductor itself. The switched capacitor may be referred to as a cap divider.

According to some implementations, the switching charger IC 111 may control the at least one switched capacitor IC 113. For example, the switching charger IC 111 may provide, to the at least one switched capacitor IC 113, control signals (e.g., a voltage control signal Vctrl, an operating voltage VDD, an operation clock CLK of the switched capacitor IC 113, and a digital control signal DIG) for the at least one switched capacitor IC 113 to perform direct charging. That is, in some implementations, the at least one switched capacitor IC 113 may provide direct charging by receiving the control signals from the switching charger IC 111, without needing to includes its own control circuit to provide direct charging. This will be described in detail below.

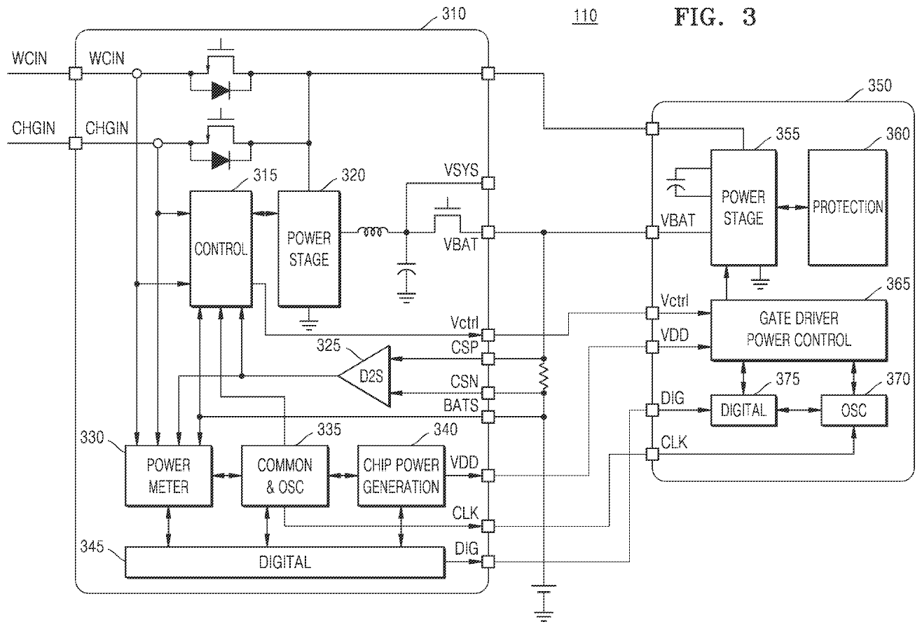

FIG. 3 shows an example of the charging IC 110 according to some implementations.

Referring to FIG. 3, the charging IC 110 may include a switching charger IC 310 and a switched capacitor IC 350. The switching charger IC 310 of FIG. 3 may correspond to the switching charger IC 111 of FIG. 2, and the switched capacitor IC 350 of FIG. 3 may correspond to the switched capacitor IC 113 of FIG. 2.

According to some implementations, the switching charger IC 310 may include a control circuit 315, a first power stage 320, a differential to single (D2S) 325, a power meter 330, a common and oscillator block 335, a chip power generation block 340, and a digital block 345.

The control circuit 315 may control the overall operation of the charging IC 110. For example, the control circuit 315 may control the charging IC 110 such that the switching charger IC 310 provides switching charging, or provides direct charging through the switched capacitor IC 350. When direct charging is required, the control circuit 315 may generate the voltage control signal Vctrl and provide the generated voltage control signal Vctrl to the switched capacitor IC 350. The voltage control signal Vctrl may be a signal for the switched capacitor IC 350 to provide a direct charging function by controlling a second power stage 355 of the switched capacitor IC 350.

The first power stage 320 may include a switched inductor. For example, the first power stage 320 may include a part of a buck converter for switching charging. The first power stage 320 may include two transistors. Each of the two transistors may correspond to a high-side switching transistor and a low-side switching transistor of the buck converter. When the charging IC 110 provides switching charging, the control circuit 315 may control charging power by adjusting an alternating cycle of turn-on and turn-off of each of the high-side switching transistor and low-side switching transistor.

The D2S 325 may perform current sensing. The D2S 325 may receive a differential input pair with respect to current sensing. For example, the D2S 325 may receive the differential input pair with respect to current sensing from each of a first current sensing positive (CSP) terminal and a second current sensing negative (CSN) terminal. The first CSP terminal may be connected to one end of a resistor connected to the battery 130, and the second CSN terminal may be connected to the other end of the resistor connected to the battery 130. The D2S 325 may output a current sensing value obtained based on the received differential input pair to the power meter 330 and the control circuit 315.

The power meter 330 may obtain information about input and output voltage and current. For example, the power meter 330 may sense the voltage and current input to the charging IC 110 and the magnitude of the voltage and current transferred to the system load 120. As another example, the power meter 330 may receive sensing values of voltage and current input to the battery 130 from the D2S 325. Although not shown, the power meter 330 may include an ADC converter, and may provide information of voltage, current, and power sensed by using the ADC converter to the first digital block 345 and digitally convert the information. The digitally converted information of the sensed voltage, current, and power may be provided to the switched capacitor IC 350. The power meter 330 may be implemented as a part of a chip of the charging IC 110 and be mounted on a printed circuit board. However, the power meter 330 is not limited thereto, and the power meter 330 and the charging IC 110 may be implemented as different ICs or IC chips.

The common and oscillator block 335 may include at least one block performing a common function of the switching charger IC 310 and the switched capacitor IC 350, and an oscillator block generating the clock signal CLK. The at least one block performing the common function may include an input current limiter (ICL) block controlling the magnitude of an input current, a fuel gauge block monitoring a state of charge (SoC) of the battery 130, etc. However, the at least one block is not limited thereto and may further include a block performing various functions. The oscillator block may generate at least two or more clock signals. For example, when the charging IC 110 provides switching charging, the oscillator block may generate a first clock signal for switching charging and provide the first clock signal to the control circuit 315. As another example, when the charging IC 110 provides direct charging, the oscillator block may generate a second clock signal for direct charging and provide the second clock signal to the switched capacitor IC 350. The first clock signal and the second clock signal may have different frequencies. The charging IC 110 is configured to provide one of switching charging or direct charging, and thus, the oscillator block may generate either the first clock signal or the second clock signal.

The chip power generation block 340 may generate the operating voltage VDD for driving the switched capacitor IC 350. For example, the chip power generation block 340 may generate and provide the operating voltage VDD to the switched capacitor IC 350 the charging IC 110 is providing direct charging. As another example, the chip power generation block 340 may bypass (or skip) generation of the operating voltage VDD to deactivate the switched capacitor IC when the charging IC 110 is providing switching charging.

The first digital block 345 may generate digital control information for controlling an input sequence during a switching charging operation of the switching charger IC 310. In addition, the first digital block 345 may generate digital control information for controlling the input sequence during a direct charging operation using the switched capacitor IC 350. The first digital block 345 may provide the generated digital control information to the switched capacitor IC 350.

The switched capacitor IC 350 may include the second power stage 355, a protection block 360, a gate driver power control block 365, an oscillator block 370, and a second digital block 375.

The second power stage 355 may include a switched capacitor. The second power stage 355 may include a switched capacitor configured in an N:1 structure for direct charging. For example, the second power stage 355 may include a switched capacitor configured in a 2:1 structure or a 4:1 structure. The switched capacitor IC 350 may provide direct charging by providing a constant current of a certain magnitude to the battery 130 by using the switched capacitor. The second power stage 355 will be described in detail below.

The protection block 360 may include at least one block for protecting the charging IC 110. The at least one block may include, for example, a block for an under-voltage lockout (UVLO) function of the switched capacitor IC 350, a block for an over-current protection (OCP) block for the switched capacitor IC 350, a block for an over-voltage protection (OVP) function of the switched capacitor IC 350, a block for a soft-start function that reduces an inrush current of the switched capacitor IC 350, a block for a foldback current limit function of the switched capacitor IC 350, a block for a hiccup mode function for short circuit protection of the switched capacitor IC 350, and/or a block for an over-temperature protection (OTP) function of the switched capacitor IC 350, etc. However, the protection block 360 is not limited to the blocks described above, and may instead or additionally include blocks performing various functions to prevent malfunction of the switched capacitor IC 350 and protect the charging IC 110 according to some implementations.

The gate driver power control block 365 may control an operation of the second power stage 355. For example, the gate driver power control block 365 may receive the operating voltage VDD from the chip power generation block 340 of the switching charger IC 310 and perform chip driving of the switched capacitor IC 350. The gate driver power control block 365 may receive the voltage control signal Vctrl from the control circuit 315 of the switching charger IC 310 and control a charging voltage and a charging current while performing direct charging.

The oscillator block 370 may generate a clock signal for the operation of the switched capacitor IC 350. For example, the oscillator block 370 may receive a second clock signal from the common and oscillator block 335 of the switching charger IC 310. The oscillator block 370 may divide the received second clock signal into clock signals of different frequencies and provide the divided clock signals to the gate driver power control block 365. The clock signal divided by the oscillator block 370 may control a period in which a plurality of gates included in the second power stage 355 are turned on or off. The second digital block 375 may generate digital control information for controlling an input sequence of a direct charging operation of the switched capacitor IC 350.

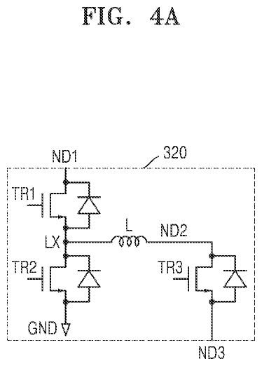

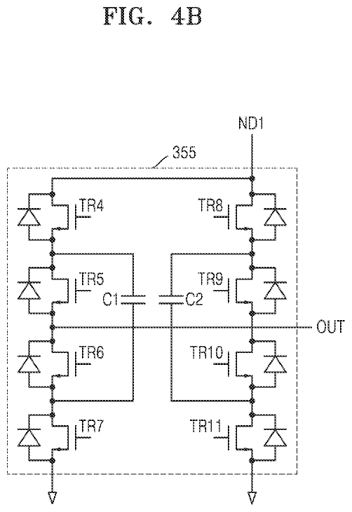

FIG. 4A is a circuit diagram illustrating an example of the first power stage 320 according to some implementations.

Referring to FIG. 4A, the first power stage 320 may include first to third transistors TR1 to TR3 and an inductor L (an example of a switched inductor). For example, each of the first to third transistors TR1 to TR3 may be implemented as a power switch. However, a structure of the first power stage 320 is not limited thereto, and according to some implementations, the number of transistors and the number of inductors included in the first power stage 320 may be changed in various ways.

The first transistor TR1 may be connected between a first node ND1 and a switching node LX, and may receive an input current through the first node ND1. The second transistor TR2 may be connected between the switching node LX and a ground node GND, and may provide a ground voltage to the switching node LX. The inductor L may be connected between the switching node LX and a second node ND2. The third transistor TR3 may be connected between the second node ND2 and a third node ND3. The third transistor TR3 may receive a voltage from the inductor L through the second node ND2 and provide the received voltage to the battery 130 through the third node ND3. When the third transistor TR3 is turned on, a charging current may be provided to the battery 130 through the third node ND3. In addition, in some implementations, when the third transistor TR3 is turned on, a battery current may be provided from the battery 130 to the system load 120. The battery current may flow in an opposite direction to the charging current.

FIG. 4B is a circuit diagram illustrating an example of the second power stage 355 according to some implementations. The arrangement of FIG. 4B corresponds to a 2:1 switched capacitor circuit. However, the scope of this disclosure is not limited to 2:1 switched capacitor arrangements, but, rather, includes N:1 switched capacitor arrangements more generally.

Referring to FIG. 4B, the second power stage 355 may include fourth to eleventh transistors TR4 to TR11, a first capacitor C1, and a second capacitor C2. For example, each of the fourth to eleventh transistors TR4 to TR11 may be implemented as a power switch. However, a structure of the second power stage 355 is not limited thereto, and the number of transistors and capacitors included in the second power stage 355 may be changed in various ways in various implementations.

The second power stage 355 may include the first capacitor C1, the second capacitor C2, and the fourth to eleventh transistors TR4 to TR11. The second power stage 355 may be referred to as a current doubler or an inverting charge pump. In a charging operation according to direct charging (e.g., as described in reference to FIG. 3), a switching operation of each of the fourth transistor TR6 to the eleventh transistor TR11 using the first capacitor C1 and the second capacitor C2 may be controlled. For example, the second capacitor C2 may be discharged while the first capacitor C1 is charged, and the second capacitor C2 may be charged while the first capacitor C1 is discharged. Accordingly, a voltage of an output node OUT provided to the battery 101 may be maintained at a constant level. A voltage value of the output node OUT may be half of a voltage level of the first node ND1.

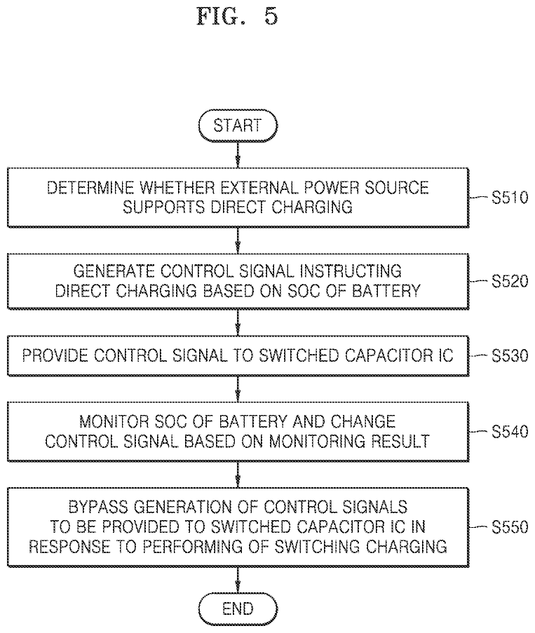

FIG. 5 is a flowchart showing an operating method of the control circuit 315 according to some implementations.

Referring to FIG. 5, in operation S510, the control circuit 315 may determine whether the external power source 200 supports direct charging. The control circuit 315 of the switching charger IC 310 may identify whether the external power source 200 connected to the electronic device 100 supports direct charging based on the receptacle interface 140. For example, the control circuit 315 may determine whether the external power source 200 supports direct charging by identifying a resistance value of a CC pin of the receptacle interface 140.

In operation S520, the control circuit 315 may generate a control signal instructing direct charging based on a SoC of the battery 130. For example, when the battery 130 is in a state of discharge or in a very low SoC (e.g., when a level of charge is a first threshold value or less), the control circuit 315 may determine to perform switching charging rather than direct charging. Alternatively, when the battery 130 is in a very high SoC (e.g., when a level of charge is a second threshold value or more), the control circuit 315 may determine to perform switching charging rather than direct charging. The control circuit 315 may determine to perform direct charging when the level of charge of the battery 130 is between the first and second threshold values. The control circuit 315 may generate a control signal in response to the determination. For example, the control circuit 315 may generate the operating voltage VDD for the switched capacitor IC 350 through the chip power generation block 340. The control circuit 315 may generate the voltage control signal Vctrl for controlling the second power stage 355 of the switched capacitor IC 350. The control circuit 315 may generate the clock signal CLK for an operating frequency of the switched capacitor IC 350 through the common and oscillator block 335. The control circuit 315 may generate digital information DIG including an input sequence for direct charging of the switched capacitor IC 350 through the first digital block 345.

In operation S530, the control circuit 315 may provide a control signal to the switched capacitor IC 350. The control signal provided to the switched capacitor IC 350 may include the voltage control signal Vctrl, the operating voltage VDD, the clock signal CLK, and the digital information DIG described above.

In operation S540, the control circuit 315 may monitor a battery SoC and change the control signal based on a monitoring result. For example, the control circuit 315 may monitor the SoC of the battery 130 through a fuel gauge block (not shown) included in the common and oscillator block 335. For example, the control circuit 315 may determine whether the level of charge of the battery 130 exceeds a third threshold value. The third threshold value may be greater than the first threshold value and less than the second threshold value. The control circuit 315 of the switching charger IC 310 may determine to perform direct charging based on a constant current (e.g., provided to the battery 130 using the switched capacitor IC 350) of a certain magnitude when the level of charge of the battery 130 is greater than the first threshold value and less than the third threshold value. The control circuit 315 may perform direct charging based on the constant current by generating control signals instructing direct charging based on the constant current and providing the control signals to the switched capacitor IC 350. The control circuit 315 of the switching charger IC 310 may determine to perform direct charging based on a constant voltage when the level of charge of the battery 130 is greater than the third threshold value and less than the second threshold value. The control circuit 315 may perform direct charging based on the constant voltage by generating control signals instructing direct charging based on the constant voltage and providing the control signals to the switched capacitor IC 350.

In operation S550, the control circuit 315 may bypass generation of the control signals to be provided to the switched capacitor IC 350 in response to performing switching charging, e.g., in response to determining to perform switching charging. According to some implementations, the control circuit 315 may determine to perform switching charging. For example, when detecting that the level of charge of the battery 130 exceeds the second threshold value, the control circuit 315 may suspend direct charging and change to switching charging to finely control an amount of charging. The control circuit 315 may suspend or bypass generation of the control signals provided to the switched capacitor IC 350 in response to the determination. For example, the control circuit 315 may not generate the voltage control signal Vctrl for controlling the second power stage 355 of the switched capacitor IC 350. The chip power generation block 340 may not generate the operating voltage VDD for driving the switched capacitor IC 350. The common and oscillator block 335 may not generate the clock signal CLK for an operating frequency of the switched capacitor IC 350. The first digital block 345 may not generate the digital information DIG for the switched capacitor IC 350.

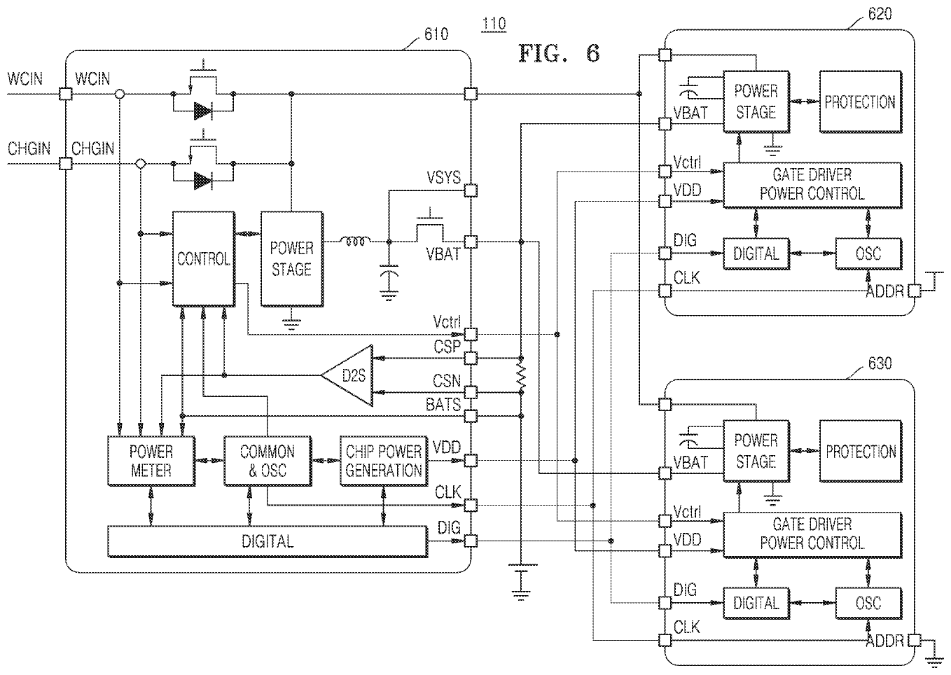

FIG. 6 shows another example of the charging IC 110 according to some implementations.

Referring to FIG. 6, the charging IC 110 may include a switching charger IC 610, a first switched capacitor IC 620, and a second switched capacitor IC 630. The switching charger IC 610 of FIG. 6 may correspond to the switching charger IC 310 of FIG. 3. Each of the first switched capacitor IC 620 and the second switched capacitor IC 630 of FIG. 6 may correspond to (e.g., may have characteristics as described for) the switched capacitor IC 350 of FIG. 3.

According to some implementations, the charging IC 110 may include at least the two switched capacitor ICs 620 and 630. For example, each of the first and second switched capacitor ICs 620 and 630 may provide the maximum charging power of 60 W. When the external power source 200 may support the maximum charging power of 60 W, the charging IC 110 may charge the battery 130 by using one IC of the first switched capacitor IC 620 and the second switched capacitor IC 630. As another example, when the external power source 200 may support the maximum charging power of 120 W, the charging IC 110 may charge the battery 130 by using both the first switched capacitor IC 620 and the second switched capacitor IC 630.

According to some implementations, the control circuit 315 may set a master IC and a slave IC with respect to the first switched capacitor IC 620 and the second switched capacitor IC 630. For example, the control circuit 315 may set the first switched capacitor IC 620 as the master IC and the second switched capacitor IC 630 as the slave IC. When using the two switched capacitor ICs 620 and 630 simultaneously, the control circuit 315 may double a frequency of the clock signal CLK generated in the common and oscillator block 335. Accordingly, the control circuit 315 may control the first switched capacitor IC 620 corresponding to the master IC to operate only on a rising edge of the clock signal CLK. The control circuit 315 may control the second switched capacitor IC 630 corresponding to the slave IC to operate only on a falling edge of the clock signal CLK.

In the example described above, the charging IC 110 is shown to include the two switched capacitor ICs 620 and 630, but the charging IC 110 is not limited thereto. According to some implementations, the charging IC 110 may include n switched capacitor ICs, and may charge the battery 130 by using at least some of the n switched capacitor ICs based on the maximum charging power supported by the external power source 200.

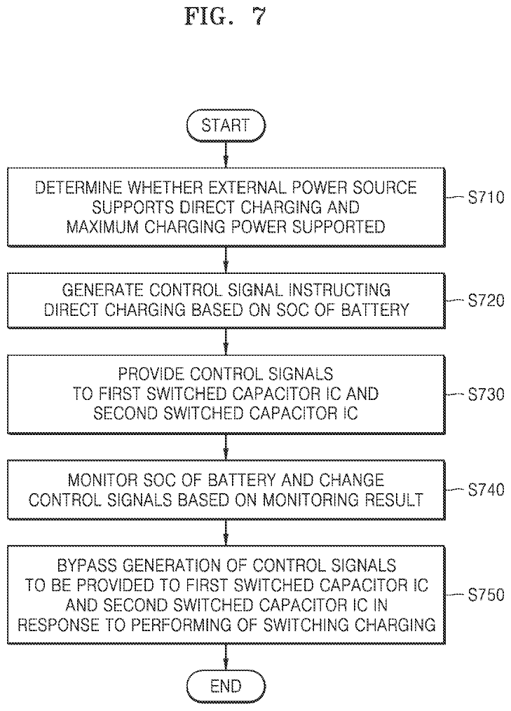

FIG. 7 is a flowchart showing an operating method of the control circuit 315 according to some implementations.

Referring to FIG. 7, in operation S710, the control circuit 315 may determine whether the external power source 200 supports direct charging and determine a maximum charging power supported. The control circuit 315 of the switching charger IC 310 may identify whether the external power source 200 connected to the electronic device 100 supports direct charging through the receptacle interface 140. For example, the control circuit 315 may determine whether the external power source 200 supports direct charging by identifying a resistance value of a CC pin of the receptacle interface 140. Additionally, the control circuit 315 may identify the maximum charging power supported by the external power source 200 through the receptacle interface 140. For example, the external power source 200 may support a maximum charging power of 120 W.

In operation S720, the control circuit 315 may generate a control signal instructing direct charging based on a SoC of the battery 130. For example, when the battery 130 is in a state of discharge or in a very low SoC (e.g., the level of charge is below a first threshold value), the control circuit 315 may determine to perform switching charging rather than direct charging. Alternatively, when the battery 130 is in a very high SoC (e.g., the level of charge is greater than a second threshold value), the control circuit 315 may determine to perform switching charging rather than direct charging. The control circuit 315 may determine to perform direct charging when the level of charge of the battery 130 is between the first and second threshold values. The control circuit 315 may generate a control signal in response to the determination. For example, the control circuit 315 may generate the operating voltage VDD for the first switched capacitor IC 620 and the second switched capacitor IC 630 through the chip power generation block 340. According to some implementations, the first operating voltage and the second operating voltage respectively provided to the first switched capacitor IC 620 and the second switched capacitor IC 630 may be the same or different. The control circuit 315 may generate the voltage control signal Vctrl for controlling a power stage of each of the first switched capacitor IC 620 and the second switched capacitor IC 630. According to some implementations, the voltage control signals Vctrl provided to the first switched capacitor IC 620 and the second switched capacitor IC 630 may be the same or different. The control circuit 315 may generate the clock signal CLK for an operating frequency of each of the first switched capacitor IC 620 and the second switched capacitor IC 630 through the common and oscillator block 335. The control circuit 315 may generate the digital information DIG including an input sequence for direct charging of the first switched capacitor IC 620 and the second switched capacitor IC 630 through the first digital block 345.

In operation S730, the control circuit 315 may provide control signals to the first switched capacitor IC 620 and the second switched capacitor IC 630. That is, the control circuit 315 identifies that charging power using the two switched capacitor ICs 620 and 630 may be supported based on the maximum charging power determined in operation S710, thereby providing the control signals to both the first switched capacitor IC 620 and the second switched capacitor IC 630. The control signals provided to the first switched capacitor IC 620 and the second switched capacitor IC 630 may include the voltage control signal Vctrl, the operating voltage VDD, the clock signal CLK, and the digital information DIG described above.

In operation S740, the control circuit 315 may monitor the battery SoC and change the control signals based on a monitoring result. For example, the control circuit 315 may monitor the SoC of the battery 130 through a fuel gauge block (not shown) included in the common and oscillator block 335. For example, the control circuit 315 may determine whether the level of charge of the battery 130 exceeds a third threshold value. The third threshold value may be greater than the first threshold value and less than the second threshold value. The control circuit 315 of the switching charger IC 310 may determine to perform direct charging based on a constant current of a certain magnitude when the level of charge of the battery 130 is greater than the first threshold value and less than the third threshold value. The control circuit 315 may perform direct charging based on the constant current by generating the control signals instructing direct charging based on the constant current and providing control signals to the first switched capacitor IC 620 and the second switched capacitor IC 630. At this time, the charging power of direct charging may be 120 W. The control circuit 315 of the switching charger IC 310 may determine to perform direct charging based on a constant voltage when the level of charge of the battery 130 is greater than the third threshold value and less than the second threshold value. The control circuit 315 may perform direct charging based on the constant voltage by generating control signals instructing direct charging based on the constant voltage and providing the control signals to the first switched capacitor IC 620 and the second switched capacitor IC 630. At this time, the charging power of direct charging may be 120 W.

In operation S750, the control circuit 315 may bypass generation of the control signals to be provided to the first switched capacitor IC 620 and the second switched capacitor IC 630 in response to performing of switching charging, e.g., in response to determining to perform switching charging. According to some implementations, the control circuit 315 may determine to perform switching charging. For example, when detecting that the level of charge of the battery 130 exceeds the second threshold value, the control circuit 315 may suspend direct charging and change to switching charging to finely control an amount of charging. The control circuit 315 may suspend or bypass generation of the control signals provided to the first switched capacitor IC 620 and the second switched capacitor IC 630 in response to the determination. For example, the control circuit 315 may not generate the voltage control signal Vctrl for controlling the power stage of each of the first switched capacitor IC 620 and the second switched capacitor IC 630. The chip power generation block 340 may not generate the operating voltage VDD for driving the first switched capacitor IC 620 and the second switched capacitor IC 630. The common and oscillator block 335 may not generate the clock signal CLK for an operating frequency of each of the first switched capacitor IC 620 and the second switched capacitor IC 630. The first digital block 345 may not generate the digital information DIG for the first switched capacitor IC 620 and the second switched capacitor IC 630.

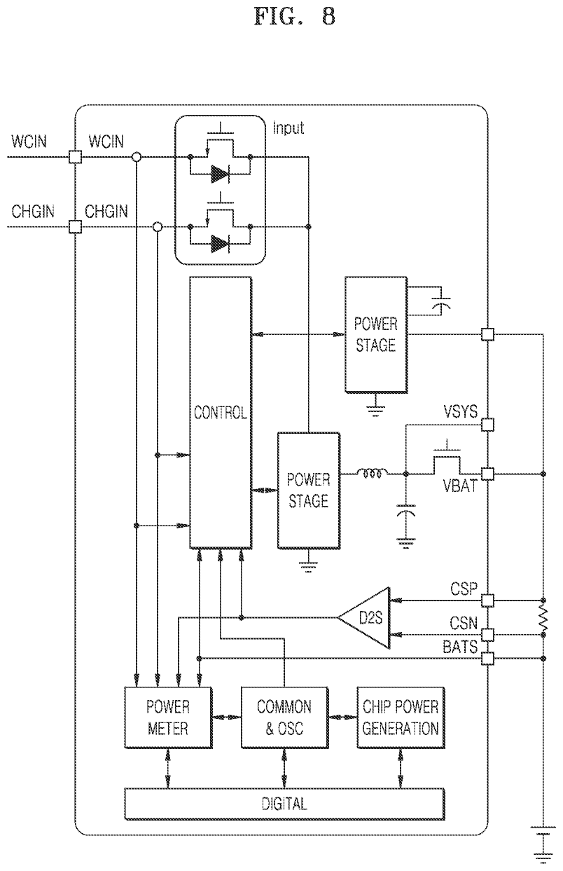

FIG. 8 shows an example of a charging IC according to a comparative example.

Referring to FIG. 8, the charging IC according to the comparative example may perform both switching charging and direct charging. That is, the charging IC according to the comparative example may include both a power stage 1 performing switching charging and a power stage 2 performing direct charging in one IC. The charging IC according to the comparative example needs to include both the power stages 1 and 2 for switching charging and direct charging, which may cause a problem in which the size of a single chip increases. In addition, even when direct charging is not supported or direct charging is not required, the charging IC according to the comparative example includes the power stage 2 for direct charging, which causes a problem in which inefficiency including an unused block occurs.

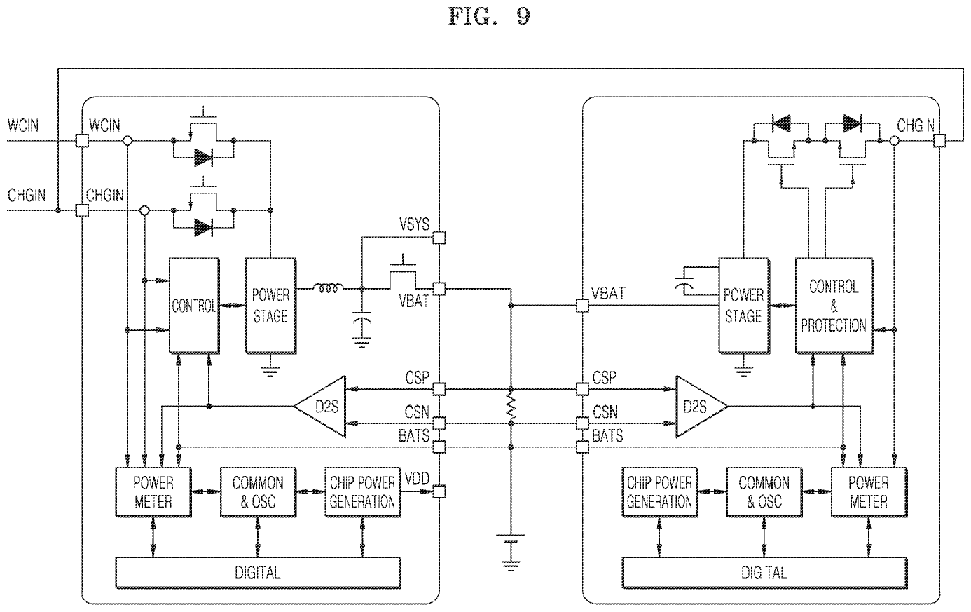

FIG. 9 shows an example of a charging IC according to a comparative example.

Referring to FIG. 9, the charging IC according to the comparative example may include two charger Ics. Referring to FIGS. 8 and 9 together, in order to compensate for the disadvantages of the charger IC according to the comparative example of FIG. 8, the charging IC according to the comparative example of FIG. 9 may include a switching charger IC and a direct charger IC. That is, the charging IC does not include both power stages for direct charging and switching charging inside a single chip but may be separated into the switching charger IC that performs switching charging and the direct charger IC that performs direct charging. The charging IC according to the comparative example may use the direct charger IC during direct charging, and the switching charger IC may be used during normal charging. However, a wired charging input terminal is generally connected to the direct charger IC, and there is a disadvantage in that one more direct charger IC connected to a wireless charging input terminal needs to be provided in order to perform direct charging based on a wireless charging input.

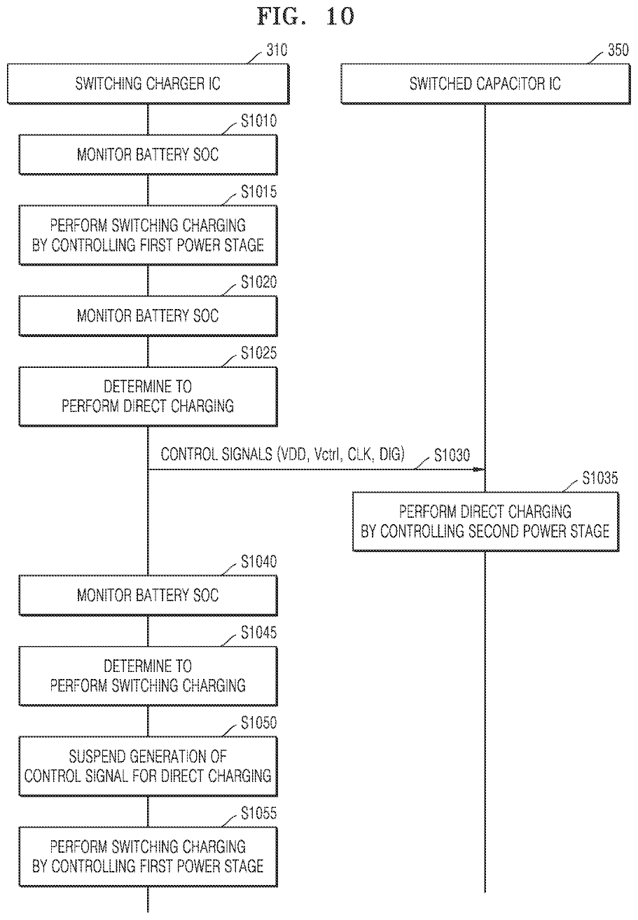

FIG. 10 is a signal exchange diagram according to some implementations.

Referring to FIG. 10, in operation S1010, the switching charger IC 310 may monitor a battery SoC. For example, the control circuit 315 may identify a level of charge of the battery 130 through a fuel gauge block (not shown).

In operation S1015, the switching charger IC 310 may perform switching charging by controlling the first power stage 320. For example, the switching charger IC 310 may charge the battery 130 by controlling turn-on and turn-off of transistors of the first power stage 320 including a switched inductor.

In operation S1020, the switching charger IC 310 may monitor the battery SoC. Operation S1020 may correspond to operation S1010.

In operation S1025, the switching charger IC 310 may determine to perform direct charging. For example, when the level of charge of the battery 130 being monitored exceeds a first threshold value and is less than a second threshold value, the switching charger IC 310 may determine to perform direct charging.

In operation S1030, the switching charger IC 310 may transmit control signals to the switched capacitor IC 350. For example, the control signals include the voltage control signal Vctrl for controlling the second power stage 355 of the switched capacitor IC 350, the operating voltage VDD for driving the switched capacitor IC 350, the clock signal CLK for an operating frequency of the switched capacitor IC 350, and the digital information DIG indicating an input sequence of direct charging.

In operation S1035, the switched capacitor IC 350 may perform direct charging by controlling the second power stage 355. For example, the gate driver control block 365 of the switched capacitor IC 350 may charge the battery 130 by controlling turn-on and turn-off of transistors of the second power stage 355 based on the voltage control signal Vctrl.

In operation S1040, the switching charger IC 310 may monitor the battery SoC. Operation S1020 may correspond to operation S1010.

In operation S1045, the switching charger IC 310 may determine to perform switching charging. For example, when the level of charge of the battery 130 being monitored exceeds the second threshold value, the switching charger IC 310 may determine to perform switching charging.

In operation S1050, the switching charger IC 310 may suspend generation of a control signal for direct charging. The switching charger IC 310 may bypass (or skip) generation of control signals provided to the switched capacitor IC 350. The switched capacitor IC 350 does not include a separate control circuit and operates based on the control signals from the switching charger IC 310, direct charging may be suspended in response to the switching charger IC 310 not generating control signals.

In operation S1055, the switching charger IC 310 may perform switching charging by controlling the first power stage 320. Operation S1055 may correspond to operation S1015.

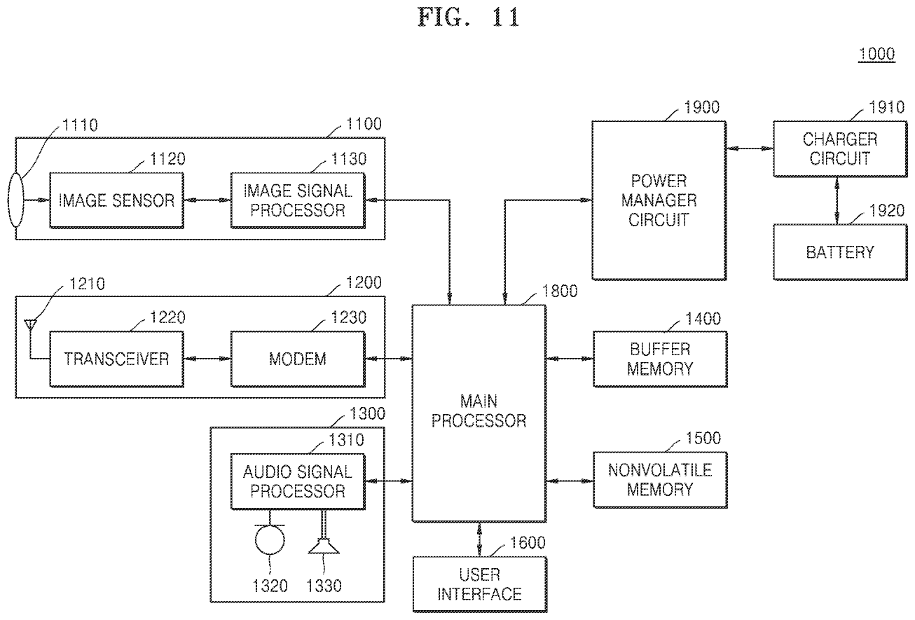

FIG. 11 is a block diagram showing a configuration of an electronic device 1000 including the charging IC 110 according to some implementations.

Referring to FIG. 11, the electronic device 1000 may include various electronic circuits. As an example, the electronic circuits of the electronic device 1000 may include an image processing block 1100, a communication block 1200, an audio processing block 1300, a buffer memory 1400, a non-volatile memory 1500, and a user interface 1600, a main processor 1800, a power management circuit 1900, and a charger circuit 1910, e.g., the charging IC 110.

The electronic device 1000 may be connected to a battery 1920. The battery 1920 may supply power used to operate the electronic device 1000. However, implementations are not limited thereto, and the power supplied to the electronic device 1000 may be provided from an internal/external power source other than the battery 1920.

The image processing block 1100 may receive light through a lens 1110. An image sensor 1120 and an image signal processor 1130 included in the image processing block 1100 may generate image information related to an external object based on the received light.

The communication block 1200 may exchange signals with an external device/system through an antenna 1210. A transceiver 1220 and a modulator/demodulator (MODEM) 1230 of the communication block 1200 may process signals exchanged with external devices/systems according to one or more of various wired/wireless communication protocols.

The audio processing block 1300 may process sound information by using an audio signal processor 1310. The audio processing block 1300 may receive an audio input through a microphone 1320 and output audio through a speaker 1330.

The buffer memory 1400 may store data used in the operation of the electronic device 1000. As an example, the buffer memory 1400 may temporarily store data processed or to be processed by the main processor 1800. As an example, the buffer memory 1400 may include a volatile memory such as Static Random Access Memory (SRAM), Dynamic RAM (DRAM), Synchronous DRAM (SDRAM), etc., and/or a non-volatile memory such as Phase-change RAM (PRAM), Magneto-resistive RAM (MRAM), Resistive RAM (ReRAM), Ferro-electric RAM (FRAM), etc.

The non-volatile memory 1500 may store data regardless of whether power is supplied. As an example, the non-volatile memory 1500 may include at least one of various non-volatile memories such as flash memory, PRAM, MRAM, ReRAM, FRAM, etc. As an example, the non-volatile memory 1500 may include a removable memory such as a Secure Digital (SD) card or solid state drive (SSD), and/or an embedded memory such as an Embedded Multimedia Card (eMMC).

The user interface 1600 may mediate communication between a user and the electronic device 1000. As an example, the user interface 1600 may include an input interface for receiving an input from the user and an output interface for providing information to the user.

The main processor 1800 may control overall operations of components of the electronic device 1000. The main processor 1800 may process various operations to operate the electronic device 1000. As an example, the main processor 1800 may be implemented as a general-purpose processor, a special-purpose processor, an application processor, a microprocessor, etc., and may include one or more processor cores.

The power management circuit 1900 may supply power to the components of the electronic device 1000 and manage power. For example, the power management circuit 1900 may output a system voltage based on power provided from the charger circuit 1910 and/or a battery 1920. The power management circuit 1900 may adjust a frequency of each component, a level of voltage of the provided system voltage, etc., according to the temperature, an operation mode (e.g., a performance mode, a standby mode, and a sleep mode), etc. of each of the components.

The charger circuit 1910 may charge the battery 1920 based on power provided from an external power source or may provide power to the power management circuit 1900. Alternatively, the charger circuit 1910 may provide power to an external device through a wired or wireless power interface based on the power provided from the battery 1920. Operations of the charger circuit 1910 may be operations described with respect to the charging IC 110 throughout this disclosure.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a combination can in some cases be excised from the combination, and the combination may be directed to a subcombination or variation of a subcombination.

While examples have been particularly shown and described, it will be understood that various changes in form and details may be made therein without departing from the spirit and scope of the following claims.

What is claimed is:

1. A charging integrated circuit (IC) comprising:
a switched capacitor IC comprising a second power stage for direct charging a battery; and
a switching charger IC comprising
a first power stage for switch-mode charging the battery,
a power meter configured to obtain information about at least one of power input to the charging IC or power output from the charging IC, and
a control circuit configured to cause switch-mode charging by controlling the first power stage and cause direct charging through the switched capacitor IC by controlling the second power stage.

2. The charging IC of claim 1, wherein
the first power stage includes a switched inductor, and
the second power stage includes a switched capacitor configured in an N:1 structure.

3. The charging IC of claim 1, wherein the switching charger IC includes a fuel gauge block configured to identify a level of charge of the battery, and
wherein the control circuit is configured to:
identify whether an external power source connected to the charging IC supports direct charging,
monitor the level of charge of the battery using the fuel gauge block, and
based on results of the monitoring, cause charging of the battery by one of direct charging or switch-mode charging.

4. The charging IC of claim 3, wherein the control circuit is configured to:
in response to the level of charge of the battery being less than a first threshold value, cause charging of the battery by switch-mode charging,
in response to the level of charge of the battery exceeding the first threshold value and being less than a second threshold value greater than the first threshold value, cause charging of the battery by direct charging, and
in response to the level of charge of the battery exceeding the second threshold value, cause charging of the battery by switch-mode charging.

5. The charging IC of claim 4, wherein the switching charger IC comprises:
a first oscillator block configured to generate a clock signal for an operating frequency of the switched capacitor IC for performing direct charging; and
a chip power generation block configured to generate an operating voltage for driving the switched capacitor IC,
wherein the control circuit is configured to generate a voltage control signal for controlling the second power stage to cause charging of the battery by direct charging.

6. The charging IC of claim 5, wherein the switched capacitor IC comprises:
a second oscillator block configured to divide the clock signal received from the switching charger IC; and
a gate driver power control block configured to control the second power stage based on the operating voltage and the voltage control signal received from the switching charger IC.

7. The charging IC of claim 1, wherein the switched capacitor IC and the switching charger IC are respectively embedded in separate chips.

8. An operating method for a charging integrated circuit (IC) comprising a switching charger IC and a switched capacitor IC, the operating method comprising:
identifying whether an external power source connected to the charging IC supports direct charging;
based on a level of charge of a battery, generating a control signal instructing direct charging of the battery and providing the control signal to the switched capacitor IC;
monitoring the level of charge of the battery;
based on results of the monitoring, performing switch-mode charging of the battery; and
based on performing switch-mode charging, bypassing generation of the control signal instructing direct charging.

9. The operating method of claim 8, wherein identifying whether the external power source connected to the charging IC supports direct charging is based on a resistance value of a CC pin of a receptacle interface.

10. The operating method of claim 8, comprising:
in response to the level of charge of the battery being less than a first threshold value, charging the battery by switch-mode charging;
in response to the level of charge of the battery exceeding the first threshold value and being less than a second threshold value greater than the first threshold value, charging the battery by direct charging; and
in response to the level of charge of the battery exceeding the second threshold value, charging the battery by switch-mode charging.

11. The operating method of claim 10, wherein charging the battery by switch-mode charging includes controlling a first power stage included in the switching charger IC, and wherein the first power stage includes a switched inductor.

12. The operating method of claim 8, wherein generating the control signal instructing direct charging comprises:
generating a clock signal for an operating frequency of the switched capacitor IC for performing direct charging;
generating an operating voltage for driving the switched capacitor IC; and
generating a voltage control signal for controlling a second power stage included in the switched capacitor IC.

13. The operating method of claim 12, wherein the second power stage includes a switched capacitor configured in an N:1 structure.

14. The operating method of claim 8, wherein the switched capacitor IC and the switching charger IC are respectively embedded in separate chips.

15. A charging integrated circuit (IC) comprising:
a first switched capacitor IC comprising a second power stage for direct charging a battery;
a second switched capacitor IC comprising a third power stage for direct charging the battery; and
a switching charger IC comprising
a first power stage for switch-mode charging the battery,
a power meter configured to obtain information about at least one of power input to the charging IC or power output from the charging IC, and
a control circuit configured to cause switch-mode charging by controlling the first power stage and cause direct charging through the first switched capacitor IC and the second switched capacitor IC by controlling the second power stage and the third power stage.

16. The charging IC of claim 15, wherein
the first power stage includes a switched inductor, and
each of the second power stage and the third power stage includes a switched capacitor configured in an N:1 structure.

17. The charging IC of claim 15, wherein the switching charger IC includes a fuel gauge block configured to identify a level of charge of the battery, and
wherein the control circuit is configured to
identify whether an external power source connected to the charging IC supports direct charging,
monitor the level of charge of the battery using the fuel gauge block, and
based on results of the monitoring, cause charging of the battery by one of direct charging or switch-mode charging.

18. The charging IC of claim 17, wherein the switching charger IC further includes
a first oscillator block configured to generate a clock signal corresponding to an operating frequency for performing direct charging through the first switched capacitor IC and the second switched capacitor IC; and
a chip power generation block configured to generate an operating voltage for driving the first switched capacitor IC and the second switched capacitor IC;
wherein the control circuit is configured to generate a voltage control signal for controlling each of the second power stage and the third power stage to cause charging of the battery by direct charging.

19. The charging IC of claim 18, wherein
the first switched capacitor IC includes
a second oscillator block configured to divide the clock signal received from the switching charger IC, and
a first gate driver power control block configured to control the second power stage based on the operating voltage and the voltage control signal received from the switching charger IC, and
wherein the second switched capacitor IC includes
a third oscillator block configured to divide the clock signal received from the switching charger IC, and
a second gate driver power control block configured to control the third power stage based on the operating voltage and the voltage control signal received from the switching charger IC.

20. The charging IC of claim 15, wherein the first switched capacitor IC, the second switched capacitor IC, and the switching charger IC are respectively embedded in separate chips.
